(19) United States
(12) Patent Application Publication
(10) Pub. No.: US 2008/0193722 A1
(43) Pub. Date: Aug. 14, 2008

(54) Hard coat film

(75) Inventor: Shukiko Tanaka, Tokyo (JP)

Correspondence Address: SQUIRE, SANDERS & DEMPSEY L.L.P., 1 MARITIME PLAZA, SUITE 300, SAN FRANCISCO, CA, 94111, US

(73) Assignee: Toppan Printing Co., Ltd., Tokyo (JP)

(21) Appl. No.: 11/998,014

(22) Filed: Nov. 27, 2007

(30) Foreign Application Priority Data
Nov. 28, 2006 (JP) 2006-319970

(51) Int. Cl. B32B 23/08; B32B 7/02

(52) U.S. Cl. 428/174; 428/533; 428/336; 428/420; 428/409

(57) ABSTRACT

According to one embodiment of this invention, there is provided a hard coat film including a triacetylcellulose film and a hard coat layer formed on the triacetylcellulose film. The hard coat layer can be formed by a coating step for forming a coating film on the triacetylcellulose film by directly applying a hard coat layer-forming coating liquid on the triacetylcellulose film, a drying step for drying the coating film, and a curing step for curing the coating film by irradiating the coating film with ionizing radiation. The hard coat layer forming-coating liquid includes a polyfunctional monomer (A) containing two or more (meth)acryloyl groups in one molecule and a crosslinking polymer (B) having a carbon-carbon unsaturated bonding. The crosslinking polymer (B) is contained in the hard coat layer-forming coating liquid at a ratio of from 10 parts by weight or more to 40 parts by weight or less with respect to 100 parts by weight of the total of the polyfunctional monomer (A) and the crosslinking polymer (B).

### CROSS REFERENCE

This application claims priority to Japanese application number 2006-319970, filed Nov. 28, 2006, which is incorporated herein by reference.

### BACKGROUND OF THE INVENTION

1. Field of the Invention

This invention relates to a hard coat film to be provided on a surface of a window, a display, and the like. Particularly, this invention relates to the hard coat film to be provided on a surface of a display such as a liquid crystal display (LCD), a CRT display, an organic electroluminescence display (ELD), a plasma display (PDP), a surface-conduction electron-emitter display (SED), and a field emission display (FED). Among the above, this invention relates to the hard coat film to be provided on the liquid crystal display (LCD) surface.

2. Description of the Related Art

A method of attaching a hard coat layer by coating an ultraviolet ray curable material has heretofore been employed for imparting hardness to a plastic film used for various displays. However, a thickness of the hard coat layer has been increased to about 30 μm in order to achieve a high pencil hardness, and, as a result of the thickness increase, a drawback of curling that is caused after forming the hard coat layer has occurred.

In order to solve these problems, a method of improving adhesion by laminating a primer layer between a substrate film and a hard coat layer has been proposed (see the following Patent Document 1, for example). However, in the case of laminating the primer layer, there are problems such as a moiré pattern that is formed by a refractive index difference between the primer layer and the substrate and a cost increase.

Also, there has been proposed a method of achieving reduced curling and a high pencil hardness by adding metal oxide particles to a hard coat layer (see the following Patent Documents 2 and 3, for example). However, this method has problems such as a reduction in transparency, deterioration due to fragility, a reduction in stability of a hard coat layer-forming coating liquid, an increase in cost, and the like.

Patent Document 1: JP-A-7-97468

Patent Document 2: JP-A-2000-159916

Patent Document 3: JP-A-2006-106427

### SUMMARY OF THE INVENTION

This invention provides a hard coat film that is: provided with a triacetylcellulose film and a hard coat layer formed on the triacetylcellulose film and having a high surface hardness; reduced in curling; and excellent in adhesion between the hard coat layer and the triacetylcellulose film as well as in transparency. According to one embodiment of this invention, there is provided a hard coat film comprising a triacetylcellulose film and a hard coat layer formed on the triacetylcellulose film, wherein: the hard coat layer is formed by a coating step for forming a coating film on the triacetylcellulose film by directly applying a hard coat layer-forming coating liquid on the triacetylcellulose film, a drying step for drying the coating film, and a curing step for curing the coating film by irradiating the coating film with ionizing radiation; the hard coat layer forming-coating liquid comprises a polyfunctional monomer (A) containing two or more (meth)acryloyl groups in one molecule and a crosslinking polymer (B) having a carbon-carbon unsaturated bonding; and the crosslinking polymer (B) is contained in the hard coat layer-forming coating liquid at a ratio of from 10 parts by weight or more to 40 parts by weight or less with respect to 100 parts by weight of a total of the polyfunctional monomer (A) and the crosslinking polymer (B).

### BRIEF DESCRIPTION OF THE DRAWINGS

FIG. 1 is a schematic sectional view showing one embodiment of hard coat film of this invention.

FIG. 2 is a schematic sectional view showing another embodiment of hard coat film of this invention.

FIG. 3 is a schematic sectional view showing yet another embodiment of hard coat film of this invention.

FIG. 4 is a sectional view showing a transmissive liquid crystal display using one embodiment of hard coat film of this invention.

### DESCRIPTION OF REFERENCE NUMERALS AND SIGNS

1: hard coat film
11: substrate film
12: hard coat layer
13: function layer
2: polarization plate
22: substrate film
23: polarization layer
3: liquid crystal cell
4: polarization plate
41: substrate film
42: substrate film
43: polarization layer
5: back light unit

### DESCRIPTION OF THE PREFERRED EMBODIMENTS

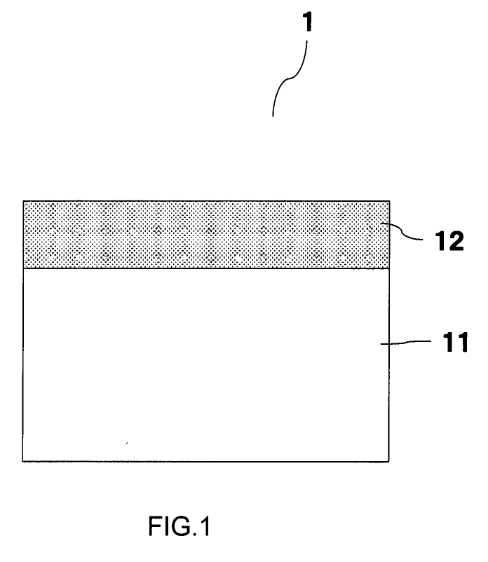

A hard coat film of this invention will be described. Shown in FIG. 1 is a schematic sectional view of the hard coat film of an embodiment of this invention. Referring to FIG. 1, the hard coat film (1) is provided with a hard coat layer (12) that is formed on a triacetylcellulose film (11).

In the hard coat film of this invention, the hard coat layer is formed by using a hard coat layer-forming coating liquid. More specifically, the hard coat layer is formed by a coating step for forming a coating film on a triacetylcellulose film by applying the hard coat layer-forming coating liquid on the triacetylcellulose film, a drying step for drying the coating film, and a curing step for curing the coating film by irradiation with ionizing radiation.

The hard coat layer forming-coating liquid can comprise a polyfunctional monomer (A) containing two or more (meth)acryloyl groups in one molecule, a crosslinking polymer (B) having a carbon-carbon unsaturated bonding, a solvent (C) that dissolves or swells the triacetylcellulose film, and a solvent (D) that does not dissolve or swell the triacetylcellulose film, and that the crosslinking polymer (B) is contained at a ratio of from 10 parts by weight or more to 40 parts by weight or less with respect to 100 parts by weight of the total of the polyfunctional monomer (A) and the crosslinking polymer (B).

In the hard coat film of this invention, the hard coat layer can be formed by forming a matrix by irradiating the polyfunctional monomer (A) containing two or more (meth)acryloyl groups in one molecule and the crosslinking polymer (B) having a carbon-carbon unsaturated bonding with the ionizing radiation.

In a hard coat film provided with a hard coat layer formed by polymerizing only the polyfunctional monomer (A) without using the crosslinking polymer (B), curling of the hard coat film becomes too much though the hard coat layer has a satisfactory surface hardness. This invention enables to obtain the hard coat film wherein the hard coat layer has a satisfactory surface hardness and is reduced in curling by adding the crosslinking polymer (B) at the ratio of from 10 parts by weight or more to 40 parts by weight or less with respect to 100 parts by weight of the total of the polyfunctional monomer (A) and the crosslinking polymer (B). The crosslinking polymer (B) may preferably be added at a ratio of from 15 parts by weight or more to 30 parts by weight or less with respect to 100 parts by weight of the total of the polyfunctional monomer (A) and the crosslinking polymer (B).

In the case where the content of the crosslinking polymer (B) is less than 10 parts by weight with respect to 100 parts by weight of the total of the polyfunctional monomer (A) and the crosslinking polymer (B), it is difficult to obtain a hard coat film having satisfactorily reduced curling. In the case where the content of the crosslinking polymer (B) exceeds 40 parts by weight with respect to 100 parts by weight of the total of the polyfunctional monomer (A) and the crosslinking polymer (B), a hard coat layer to be formed fails to have the satisfactory surface hardness.

The polyfunctional monomer can have two or more (meth)acryloyl groups in one molecule. In this invention, the (meth) acryloyl group means an acryloyl group or a methacryloyl group. A satisfactorily high surface hardness of a hard coat layer to be formed can be achieved by using the polyfunctional monomer having 2 or more functional groups.

The crosslinking polymer (B) can have carbon-carbon unsaturated bonding. Due to the carbon-carbon unsaturated bonding, a reaction with the (meth)acryloyl group of the polyfunctional monomer (A) is caused by irradiation with ionizing radiation, and a hard coat layer to be formed has a crosslink structure of the polyfunctional monomer (A) and the crosslinking polymer (B). In the case where the crosslinking polymer (B) does not have the carbon-carbon unsaturated bonding, a crosslink density of the polyfunctional monomer (A) is roughened resulting in prominent reduction in surface hardness of the hard coat layer made from the polyfunctional monomer (A) and the crosslinking polymer (B).

The hard coat film of this invention is scratch resistant due to the high surface hardness of the hard coat layer. A surface of the hard coat layer becomes brittle when the surface hardness is low. The hard coat film of this invention is reduced in degree of curling. When a hard coat film has a high degree of curling, scratches are caused on the hard coat film when the hard coat film is brought into contact with an apparatus during transportation in a post-process and the like. Also, since the hard coat film is to be provided on a display surface by a process of attaching the hard coat film with another member, the high degree of curling makes it difficult to attach the hard coat film to the member. Since the hard coat film of this invention is excellent in adhesion between the hard coat layer and triacetylcellulose, a problem of peeling of hard coat layer does not occur even when the hard coat film is provided as a protection member of the display surface for a long time. Also, this invention realizes the hard coat film having the hard coat layer with the high surface hardness without addition of particles to the hard coat layer, and the hard coat film of this invention is reduced in curling.

In the hard coat film of this invention, a weight average molecular weight (Mw) of the crosslinking polymer having the carbon-carbon unsaturated bonding may preferably be in the range of from 2,000 or more to 50,000 or less. In the case where the weight average molecular weight of the crosslinking polymer is less than 2,000, it is difficult to satisfactorily suppress the degree of curling. In the case where the weight average molecular weight of the crosslinking polymer exceeds 50,000, it is difficult to stably melt the crosslinking polymer (B) into the hard coat layer-forming coating liquid or a viscosity of the coating liquid is increased too much to adversely influence on coating processing suitability. In this invention, the weight average molecular weight (Mw) of the crosslinking polymer (B) is measured by gel permeation chromatography.

In the hard coat film of this invention, it is preferable that the hard coat layer does not contain particles. It is possible to obtain a hard coat film having a high transparency when the hard coat layer does not contain particles. In this invention, it is possible to obtain the hard coat layer having the high surface hardness and the hard coat film reduced in curling without using particles.

In the hard coat film of this invention, a thickness of the hard coat layer may preferably be from 3 μm or more to 20 μm or less. In the case where the thickness of the hard coat layer is less than 3 μm, it is difficult to obtain the hard coat layer having the satisfactory surface hardness. In the case where the thickness of the hard coat layer exceeds 20 μm, it is difficult to satisfactorily suppress curling of a hard coat film to be formed.

In the hard coat film of this invention, the hard coat layer-forming coating liquid can contain a solvent. In the case where the hard coat layer is directly formed on the triacetylcellulose film, the solvent comprises solvent (C) that dissolves triacetylcellulose and the solvent (D) that does not dissolve triacetylcellulose, and the solvent (C) that dissolve triacetylcellulose is contained at a ratio of from 30 parts by weight or more to 70 parts by weight or less with respect to 100 parts by weight of the total of the solvents.

By using the hard coat layer-forming coating liquid containing the solvent (C) that dissolves the triacetylcellulose film, a surface of the triacetylcellulose film is dissolved or swollen during a period from the application of the hard coat layer-forming coating liquid on the triacetylcellulose film to removal of the solvent by a drying process. In this case, an intermediate layer in which a triacetylcellulose film component and a hard coat layer component are mixed is formed at a boundary between the triacetylcellulose film and the hard coat layer. With the intermediate layer in which the triacetylcellulose film component and the hard coat layer component are mixed, which is formed at the boundary, it is possible to improve the adhesion of the hard coat layer to the triacetylcellulose film.

In the hard coat layer-forming coating liquid, the solvent (C) that dissolves the triacetylcellulose film may preferably be contained at a ratio of from 30 parts by weight or more to 70 parts by weight or less with respect to 100 parts by weight of the total of the solvents. When the solvent (C) that dissolves the triacetylcellulose film is less than 30 parts by weight with respect to 100 parts by weight of the total of the solvents, it is difficult to satisfactorily form the intermediate layer in which the triacetylcellulose film component and the hard coat layer component are mixed, thereby failing to achieve satisfactory adhesion at the boundary between the triacetylcellulose film and the hard coat layer in some cases. When the solvent (C) that melts the triacetylcellulose film exceeds 70 parts by weight with respect to 100 parts by weight of the total of the solvents, a thickness of the intermediate layer in which the triacetylcellulose film component and the hard coat layer component are mixed becomes too large to reduce the surface hardness of the hard coat layer in some cases.

The hard coat film of this invention is characterized in that: (1) a curling curvature radius of a longitudinal side of a sheet of the hard coat film having the size of 50 mm×2 mm can be 80 mm or more; (2) a result of experiment obtained by conducting a test of moving a pencil of 4H on the hard coat layer surface of the hard coat film with a load of 500 g being applied by using a coating film pencil scratch tester for 5 times is such that no scratches are observed on the hard coat surface in 3 or more tests out of the 5 tests; (3) the number of remaining squares of the hard coat layer can be 100 in a cross cut peel test conducted by forming 100 squares each having the size of 1 mm×1 mm on the hard coat layer surface by cutting; and (4) a haze value of the hard coat film can be 0.4% or less.

Due to the characteristic (1) a curling curvature radius of a longitudinal side when the hard coat film has the size of 50 mm×2 mm is 80 mm or more, the hard coat film is reduced in curling, thereby preventing damages on the hard coat film otherwise caused by contact with an apparatus during transportation in a post-process and the like. Also, in a process of attaching the hard coat film to another member, the hard coat film is easily attached to the member.

Due to characteristic (2) a result of experiment obtained by conducting a test of moving a pencil of 4H on the hard coat layer surface of the hard coat film with a load of 500 g being applied by using a coating film pencil scratch tester for 5 times is such that no scratches are observed on the hard coat surface in 3 or more tests out of the 5 tests, the hard coat film becomes scratch resistant.

Due to characteristic (3) the number of remaining squares of the hard coat layer is 100 in a cross cut peel test conducted by forming 100 squares each having the size of 1 mm×1 mm on the hard coat layer surface by cutting, the hard coat film has high adhesion between the hard coat layer and the triacetylcellulose film and is free from the problem of peeling of the hard coat layer.

Due to characteristic (4) a haze value of the hard coat film is 0.4% or less, the hard coat film has high transparency.

The hard coat film of this invention can be provided with the hard coat layer that can be formed on the triacetylcellulose film, and, further, a function layer may be provided on the hard coat layer. As the function layer, those having an anti-reflection property, an antistatic property, an anti-fouling property, an electromagnetic wave-shielding property, an infrared ray absorption property, an ultraviolet ray absorption property, a color correction property, and the like may be used. Examples of such function layers include an anti-reflection layer, an antistatic layer, an anti-fouling layer, an electromagnetic wave-shielding layer, an infrared ray absorption layer, an ultraviolet ray absorption layer, a color correction layer, and the like. The function layer may be a single layer or may be formed of a plurality of layers. For example, the anti-reflection layer may be formed of a single low refractive index layer or may be formed of plural layers of a low refractive index layer and a high refractive index layer that are alternately laminated. Also, the single function layer may have a plurality of functions such as an anti-reflection layer having anti-fouling property. The function layer may be provided between the triacetylcellulose film and the hard coat layer.

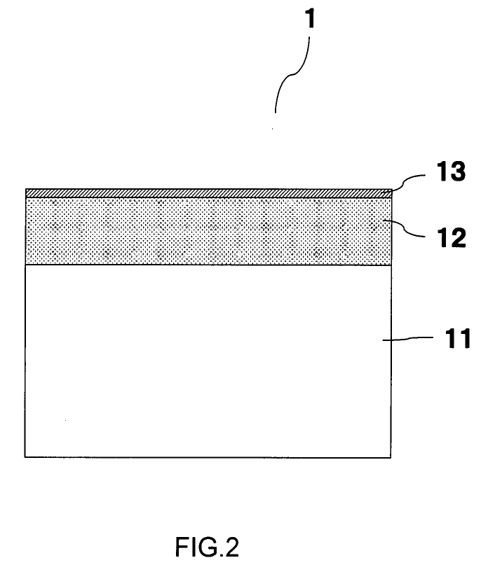

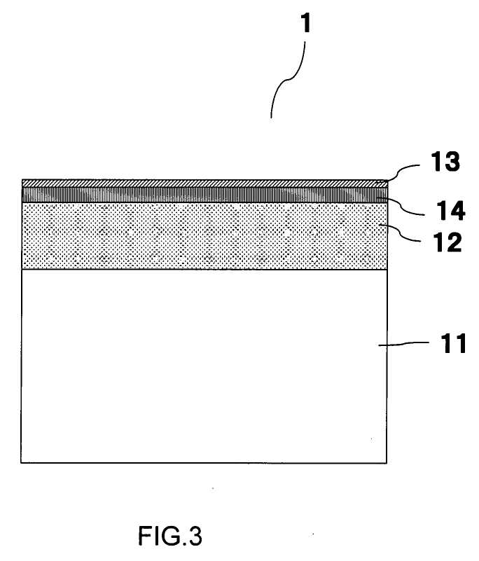

Shown in FIG. 2 is a schematic sectional view of another embodiment of hard coat film of this invention. In FIG. 2, the hard coat film (1) of this invention is provided with a triacetylcellulose film (11), a hard coat layer (12) formed on the triacetylcellulose film (11), and an anti-reflection layer (13) formed on the hard coat layer. Shown in FIG. 3 is a schematic sectional view of yet another embodiment of hard coat film of this invention. In FIG. 3, the hard coat film (1) of this invention is provided with a triacetylcellulose film (11), a hard coat layer (12) formed on the triacetylcellulose film (11), and an antistatic layer (14) and an anti-reflection layer (13) are formed on the hard coat layer in this order.

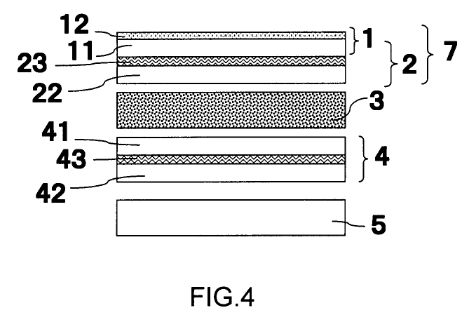

Shown in FIG. 4 is a sectional view of a transmissive liquid crystal display using the hard coat film of this invention. The transmissive liquid crystal display of FIG. 4 is provided with a backlight unit (5), a polarization plate (4), a liquid crystal cell (3), a polarization plate (2), and a hard coat film (1) in this order. The side of the hard coat film (1) is a side to be viewed, i.e. the display surface.

The backlight unit (5) is provided with a light source and a light diffusion plate. The liquid crystal cell has such a structure that: an electrode is provided on one of transparent substrates; an electrode and a color filter are provided on the other transparent substrate; and a liquid crystal is enclosed between the electrodes. Each of the polarization plates sandwiching the liquid crystal cell (3) has such a structure that a polarization layer (23 or 43) are sandwiched between the transparent substrates (11, 22, or 41, 42).

In FIG. 4, the polarization layer (23) is provided on a surface opposite to the hard coat layer of the triacetylcellulose film (11) of the hard coat film (1), and the triacetylcellulose film (11) is used as a transparent substrate of the hard coat film (1) and the triacetylcellulose film of the polarization plate (2).

The transmissive liquid crystal display of this invention may be provided with another function member. Examples of the function member include a diffusion film, a prism sheet, and a brightness improvement film that are used for utilizing the light emitted from the backlight, a phase difference film that is used for compensating for a phase difference of the liquid crystal cell and the polarization plate, and the like.

A production process for the hard coat film of this invention will be described below. The hard coat film of this invention can be formed by using the hard coat layer-forming coating liquid containing the polyfunctional monomer (A) containing two or more (meth) acryloyl groups in one molecule and the crosslinking polymer (B) having the carbon-carbon unsaturated bonding at a side chain. More specifically, the hard coat film can be formed by a coating step for forming a coating film on the triacetylcellulose film by directly applying the hard coat layer-forming coating liquid on the triacetylcellulose film, a drying step for drying the coating film, and a curing step for curing the coating film by irradiating the coating film with ionizing radiation.

The triacetylcellulose film of this invention is reduced in double refraction and excellent in optical characteristics such as transparency, refractive index, and dispersion as well as physical properties such as impact resistance, heat resistance, and durability. Further, since the triacetylcellulose film is easily dissolved or swollen with the use of a commercially available solvent, the triacetylcellulose film is preferred among other films in this invention. Various stabilizers, ultraviolet ray absorbers, plasticizers, lubricants, colorants, antioxidants, flame retarders, and the like may be added to the triacetylcellulose film. A thickness of the triacetylcellulose film may preferably be in the range of from 25 μm or more to 200 μm or less, more preferably in the range of from 40 μm or more to 80 μm or less.

In the case of using the hard coat film of this invention as a part of a polarization plate, a drawn polyvinylalcohol (PVA) to which iodide is added may be used, for example, as a polarization layer to be provided on a surface opposite to a surface of the triacetylcellulose film provided with hard coat layer.

The polyfunctional monomer (A) contains two or more (meth)acryloyl groups in one molecule. As used herein, the (meth) acryloyl group means an acryloyl group or a methacryloyl group. Those usable as the polyfunctional monomer include 1,4-butanediol di(meth)acrylate, 1,6-hexanediol di(meth)acrylate, neopentylglycol (meth)acrylate, ethyleneglycol di(meth)acrylate, triethyleneglycol di(meth)acrylate, tripropyleneglycol di(meth)acrylate, dipropyleneglycol di(meth)acrylate, 3-methylpentanediol di(meth)acrylate, diethyleneglycol bis-β-(meth)acryloyloxypropionate, trimethylolethanetri(meth)acrylate, trimethylolpropanetri(meth)acrylate, pentaerythritoltri(meth)acrylate, pentaerythritoltriacrylate, dipentaerythritolhexa(meth)acrylate, tri(2-hydroxyethyl)isocyanate di(meth)acrylate, pentaerythritoltetra(meth)acrylate, 2,3-bis(meth)acryloyloxyethyloxymethyl[2.2.1]heptane, poly-1,2-butadiene di(meth)acrylate, 1,2-bis(meth)acryloyloxymethylhexane, nonaethyleneglycol di(meth)acrylate, tetradecanethyleneglycol di(meth)acrylate, 10-decandiol(meth)acrylate, 3,8-bis(meth)acryloyloxymethyltricyclo[5.2.10]decan, hydrogenated bisphenol-A di(meth)acrylate, 2,2-bis(4-(meth)acryloyloxydiethoxyphenylpropane, 1,4-bis((meth)acryloyloxymethyl)cyclohexane, hydroxypivalate ester neopentylglycol di(meth)acrylate, bisphenol-A diglycidylether di(meth)acrylate, epoxy-modified bisphenol-A di(meth)acrylate, and the like.

As the polyfunctional monomer, urethane acrylate may also be used. The urethane acrylate is obtainable by reacting a polyvalent alcohol, polyvalent isocyanate, and hydroxyl group-containing acrylate, and specific examples thereof include UA-306H, UA-306T, UA-3061, and the like that are manufactured by Kyoeisha Chemical Co., Ltd.; UV-1700B, UV-6300B, UV-7600B, UV-7605B, UV-7640B, UV-7650B, and the like that are manufactured by Nippon Synthetic Chemical Co., Ltd; U-4HA, U-6HA, UA-100H, U-6LPA, U-15HA, UA-32P, U-324A, and the like that are manufactured by Shin-Nakamura Chemical Co., Ltd.; Ebecryl-1290, Ebecryl-1290K, Ebecryl-5129, and the like that are manufactured by Daicel-Cytec Company, Ltd.; UN-3220HA, UN-3220HB, UN-3220HC, UN-3220HS, and the like that are manufactured by Negami Chemical Industries Co., Ltd.; and the like.

The polyfunctional monomers may be used alone or in combination of two or more. The polyfunctional monomers in the coating liquid may be a monomer or a partially polymerized oligomer.

As the crosslinking polymer (B) of this invention, a polymer having a carbon-carbon unsaturated bonding at a side chain may be used. As the carbon-carbon unsaturated bonding at side chain, a (meth)acryloyl group may preferably be used. A weight average molecular weight of the crosslinking polymer may preferably be 2,000 or more to 50,000 or less.

Preferred examples of the crosslinking polymer (B) include an esteracrylate copolymer having a (meth)acryloyl group as a pendant group represented by the following [Chem. 1]:

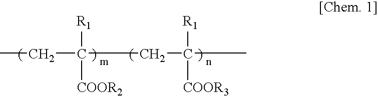

wherein R₁ represents H or a methyl group; R₂ represents a residual group having a —CR═CH₂ group at a terminal; R₃ represents a substitution group selected from an alkyl group, an aryl group, and the like; and m+n=1.

The hard coat layer-forming coating liquid can contain a solvent. The solvent may preferably be formed of the solvent (C) that dissolves the triacetylcellulose film and the solvent (D) that does not dissolve the triacetylcellulose film, and the solvent (C) that dissolves the triacetylcellulose film may preferably be contained at a ratio of from 30 parts by weight to 70 parts by weight with respect to 100 parts by weight of the total solvents.

Examples of the solvent (C) that dissolve the triacetylcellulose film include ethers such as dibutylether, dimethoxymethane, dimethoxyethane, diethoxyethane, propyleneoxide, 1,4-dioxane, 1,3-dioxolan, 1,3,5-trioxane, tetrahydrofuran, anisole, and phenetol; a part of ketones such as acetone, acetylacetone, methylethylketone, diethylketone, dipropylketone, diisobutylketone, cyclopentanone, cyclohexanone, 2-methylcyclohexanone, and 4-methylcyclohexanone; esters such as ethyl formate, propyl formate, n-pentyl formate, methyl acetate, ethyl acetate, methyl propionate, ethyl propionate, n-pentyl acetate, and y-butylolactone; cellosolves such as methylcellosolve, cellosolve, butylcellosolve, and cellosolve acetate; and the like. These solvents may be used alone or in combination of two or more. Among the above, those selected from dibutylether, dimethoxyethane, methyl acetate, ethyl acetate, methylethylketone, acetylacetone, and cyclohexanone may be used. At least one of these solvents may be used, and the solvents may be used in combination of two or more.

As the solvent (D) that does not dissolve the triacetylcellulose film, hydrocarbons and a part of ketones may be used. More specifically, aromatic hydrocarbons such as toluene, xylene, cyclohexane, n-hexane, cyclohexylbenzene; a part of ketones such as methylisobutylketone and methylbutylketone; and the like may be used. These solvents may be used alone or in combination of two or more. Among the above, at least one selected from toluene, xylene, cyclohexane, n-hexane, and methylisobutylketone is preferred.

A total content of the solvent (C) that dissolves the triacetylcellulose film and the solvent (D) that does not dissolve the triacetylcellulose film may preferably be 10 parts by weight or more to 80 parts by weight or less, particularly preferably 30 parts by weight or more to 70 parts by weight or less, with respect to 100 parts by weight of the whole hard coat layer-forming coating liquid. When the total solvent content is less than 10 parts by weight, a viscosity of the coating liquid tends to be increased to make it difficult to form a hard coat layer having a uniform in-plane thickness. When the total solvent content exceeds 80 parts by weight, productivity tends to be reduced.

A photopolymerization initiator may be added to the hard coat layer-forming coating liquid of this invention. Particularly when using an ultraviolet ray as the ionizing radiation, it is necessary to add the photopolymerization initiator to the coating liquid. Examples of the photopolymerization initiator include 2,2-ethoxyacetophenone, 1-hydroxycyclohexylphenylketone, dibenzoyl, benzoin, benzoinmethylether, benzomethylether, p-chlorobenzophenone, p-methoxybenzophenone, Michler's ketone, acetophenone, 2-chlorothioxanthone, and the like. These photopolymerization initiators may be used alone or in combination of two or more.

Further, a photosensitizer may be added to the hard coat layer-forming coating liquid of this invention. Examples of the photosensitizer include tertiary amines such as triethylamine, triethanolamine, and 2-dimethylaminoethanol; alkylphosphines such as triphenylphosphine; thioethers such as β-thiodiglycol; and the like, and these photosensitizers may be used alone or in combination of two or more.

Further, for the purpose of improving properties, an anti-foaming agent, a leveling agent, an antioxidant, an ultraviolet ray absorber, a light stabilizer, a polymerization inhibitor, and the like may be added.

Further, an additive such as an anti-foaming agent, a leveling agent, an antioxidant, an ultraviolet ray absorber, a light stabilizer, a polymerization inhibitor, an antistatic agent, an anti-foulant, a water repellant, a refractive index adjuster, an adhesion improver, and the like may be added to the hard coat layer-forming coating liquid.

The hard coat layer-forming coating liquid is directly applied on the triacetylcellulose film. As a coating method, a wet coating method may be employed. As the wet coating method, dip coating, spin coating, flow coating, spray coating, roll coating, gravure roll coating, air doctor coating, blade coating, wire doctor coating, knife coating, reverse coating, transfer roll coating, micro-gravure coating, kiss coating, cast coating, slot orifice coating, calendar coating, die coating, or the like may be employed. The hard coat layer-forming liquid is directly applied on the triacetylcellulose by any of the above wet coating methods.

Subsequently, the coating film formed on the triacetylcellulose film is dried so that the solvents in the coating film are removed. As a drying method, drying by air blasting, heating using an oven, or the like may be performed.

Subsequently, the hard coat layer is formed by irradiating the coating film on the triacetylcellulose film from which the solvents are removed with the ionizing radiation. As the ionizing radiation to be used for the ionizing radiation curing process, an ultraviolet ray or an electron ray may be used. In the case of the ultraviolet ray curing, a lamp with electrode such as a high pressure mercury lamp, a halogen lamp, and a xenon lamp; a lamp without electrode such as fusion lamp; or the like may be used. The amount of the ultraviolet ray irradiation can be within a range of 100 to 800 mJ/cm². In the case of the electron ray curing, an electron ray emitted from various electron ray accelerators such as a Cockroft-Walton accelerator, a Van de Graaff accelerator, a resonance transformer accelerator, an insulated core transformer accelerator, a linear accelerator, a dynamitoron accelerator, a high frequency accelerator, and the like may be used. The electron ray may preferably have energy of 50 to 1,000 KeV. The electron ray having energy of 100 to 300 Kev is more preferable.

The hard coat layer is formed as described above. A method for forming the anti-reflection layer as the function layer to be provided on the hard coat layer in the hard coat film of this invention will be described below.

Examples of the anti-reflection layer to be provided on the hard coat layer as the function layer include an anti-reflection layer having a lamination structure wherein a high refractive index layer and a low refractive index layer are laminated alternately and an anti-reflection layer having a single layer structure formed of a single low refractive index layer. The method for forming the anti-reflection layer can be classified into a method employing a vacuum film formation method such as a vacuum vapor deposition, sputtering, and CVD and a method employing a wet film formation method by applying an anti-reflection layer-forming coating liquid on a hard coat layer surface.

A method for forming, as the anti-reflection layer, the low refractive index single layer by the wet film formation method by applying the low refractive index layer-forming coating liquid on the hard coat layer surface will be described below. A film thickness (d) of the low refractive index single layer serving as the anti-reflection layer is so designed as to keep an optical film thickness (nd) which is obtained by multiplying the film thickness (d) by a refractive index (n) of the low refractive index layer to a value that is ¼ of a wavelength of visible light. As the low refractive index layer, a layer in which low refractive index particles are dispersed in a binder matrix may be used.

Examples of the low refractive index particles include those formed from a low refractive index material such as magnesium fluoride and calcium fluoride. Also, particles each having a clearance inside may be suitably used as the low refractive index particles. Since a refractive index at the clearance of the particles having clearance inside is equal to an air refractive index (almost equal to 1), the low refractive index particles has the remarkably low refractive index. More specifically, low refractive index silica particles each having a clearance inside may be used.

As a material for forming the binder matrix, an ionizing radiation material such as polyfunctional acrylate such as acrylic acid of a polyvalent alcohol and ester methacrylate and polyfunctional urethane acrylate which can be synthesized from diisocyanate, a polyvalent alcohol, hydroxyester of acrylic acid or methacrylic acid may be used. In addition to the above examples, ionizing radiation materials such as a polyether resin, a polyester resin, an epoxy resin, an alkyd resin, a spiroacetal resin, a polybutadiene resin, and a polythiolpolyene resin, each having an acrylate functional group, and the like are usable. In the case of using the ionization radiation-curable materials described above, the binder matrix is formed by irradiation with ionizing radiation such as an ultraviolet ray and an electron ray. Also, as the binder matrix-forming material, metal alkoxide such as silicon alkoxide of tetramethoxysilane, tetraethoxysilane, and the like may be used. A binder matrix based on silicon oxide which is a metal oxide is obtainable from the metal alkoxide through hydrolysis and dehydration condensation.

The low refractive index layer-forming coating liquid containing the low refractive index material and the binder matrix-forming material can be applied on the hard coat layer surface. A solvent and various additives may be added to the low refractive index layer-forming coating liquid when so required. The solvent may be appropriately selected in view of coating processing suitability and the like from aromatic hydrocarbons such as toluene, xylene, cyclohexane, cyclohexylbenzene; hydrocarbons such as n-hexane; ethers such as dibutylether, dimethoxymethane, dimethoxyethane, diethoxyethane, propyleneoxide, dioxane, dioxolan, trioxane, tetrahydrofuran, anisole, and phenetol; ketones such as methylisobutylketone, methylbutylketone, acetone, methylethylketone, diethylketone, dipropylketone, diisobutylketone, cyclopentanone, cyclohexanone, 2-methylcyclohexanone, and 4-methylcyclohexanone; esters such as ethyl formate, propyl formate, n-pentyl formate, methyl acetate, ethyl acetate, methyl propionate, ethyl propionate, n-pentyl acetate, and y-butylolactone; cellosolves such as methylcellosolve, cellosolve, butylcellosolve, and cellosolve acetate; alcohols such as methanol, ethanol, and isopropyl alcohol; water; and the like. As the additives, a surface adjuster, an antistatic agent, an anti-foulant, a water repellent, a refractive index adjuster, an adhesion improver, a curing agent, and the like may be added.

As a coating method, dip coating, spin coating, flow coating, spray coating, roll coating, gravure roll coating, air doctor coating, blade coating, wire doctor coating, knife coating, reverse coating, transfer roll coating, micro-gravure coating, kiss coating, cast coating, slot orifice coating, calendar coating, die coating, or the like may be employed.

In the case where the ionizing radiation-curable material is used as the binder matrix-forming material, the low refractive index layer is formed by subjecting the coating film which is obtained by applying the coating liquid on the hard coat layer to irradiation with ionizing radiation after performing drying as required. In the case where the metal alkoxide is used as the binder matrix-forming material, the low refractive index layer is formed through a heating process such as drying and heating.

A case of forming the anti-reflection layer wherein the low refractive index layer and the high reflective index layer are alternately laminated by employing the vacuum film formation method will be described. Examples of the alternate lamination structure of the low refractive index layer and the high reflective index layer of the anti-reflection layer include a two-layer structure formed of a high refractive index layer and a low refractive index layer that are laminated in this order on the hard coat layer and a four-layer structure formed of a high refractive index layer, a low refractive index layer, a high refractive index layer, and a low refractive index layer that are laminated in this order on the hard coat layer may be selected.

Examples of a material for forming the high refractive index layer include metals such as indium, tin, titanium, silicon, zinc, zirconium, niobium, magnesium, bismuth, cerium, tantalum, aluminum, germanium, potassium, antimony, neodymium, lanthanum, thorium, and hafnium; alloys comprising two or more of the metals; oxides, fluorides, sulfides, and nitrides of the metals; and the like. More specifically, a metal oxide such as titanium oxide, niobium oxide, zirconium oxide, tantalum oxide, zinc oxide, indium oxide, cerium oxide, and indium tin oxide may be used. In the case of laminating the plural high reflective index layers, it is not always necessary to select an identical material for the layers, and it is possible to select the materials in accordance with the purpose.

Examples of a material for forming the low refractive index layer include, but not limited to, silicon oxide, titanium nitride, magnesium fluoride, barium fluoride, calcium fluoride, hafnium fluoride lanthanum fluoride, and the like. In the case of laminating the plural low reflective index layers, it is not always necessary to select an identical material for the layers, and it is possible to select the materials in accordance with the purpose. Particularly, in view of optical characteristics, mechanical strength, cost, film formation properties, and the like, silicon oxide which is a metal oxide is the most suitable material.

It is possible to form the anti-reflection layer by forming films of the high refractive index material and the low refractive index material one by one by the vacuum film formation method. As the vacuum film formation method, vapor deposition, ion plating, ion beam assist, sputtering, or CVD may be employed. In the anti-reflection layer, a medium refractive index layer may be provided between the high refractive index layer and the low refractive index layer.

Examples of a method for providing the antistatic layer as the function layer include a method of forming a film by using a metal oxide such as zinc oxide, indium oxide, and indium tin oxide and employing a vacuum film formation. Also, it is possible to form an antistatic layer in which electroconductive metal oxide particles are dispersed in a binder matrix by applying an antistatic layer-forming coating liquid containing the electroconductive metal oxide particles such as zinc oxide, indium oxide, and indium tin oxide and a binder matrix-forming material on the hard coat layer, followed by ionizing radiation irradiation and heating as required.

Before forming the function layer on the hard coat layer, a surface treatment such as an acid treatment, an alkali treatment, a Colona treatment, and an atmospheric pressure glow discharge plasma treatment may be performed. By performing the surface treatment, it is possible to further improve the adhesion between the hard coat layer and the function layer.

In the case of forming, on the hard coat layer, the function layer such as the anti-reflection layer and the antistatic layer by using the metal alkoxide such as silicon alkoxide as the binder matrix-forming material, it is preferable to perform a saponifying treatment before forming the function layer. It is possible to further improve the adhesion between the hard coat layer and the function layer by performing an alkali treatment.

The hard coat film having the above-described structure has the hard coat layer having the high surface hardness and the reduced curling and is excellent in adhesion between the hard coat layer and the triacetylcellulose film as well as in transparency.

### EXAMPLES

Though examples of this invention will be described below, this invention is not limited to the following examples.

### Example 1

A hard coat layer-forming coating liquid that was stirred and mixed as described below was applied and dried on triacetylcellulose (total light transmittance: 93%; haze value: 0.2%) having a thickness of 80 μm by bar coating so as to achieve a film thickness after drying of 12 μm, and ultraviolet ray irradiation (600 mJ/cm²) was performed on the coating by using a high pressure mercury lamp to prepare a hard coat film.

### (Composition of Hard Coat Layer-Forming Coating Liquid)

PE-3A (pentaerythritoltriacrylate; product of Kyoeisha Chemical Co., Ltd.): 80 parts by weight

BGV-12 (crosslinking polymer; product of Soken Chemical and Engineering, Co., Ltd.; weight average molecular weight: 3,000): 20 parts by weight

Irgacure-184 (photopolymerization initiator; product of Ciba Specialty Chemicals, Inc.): 5 parts by weight

Methyl acetate: 50 parts by weight

Methylisobutylketone: 50 parts by weight

### Example 2

A hard coat film was prepared in the same manner as in Example 1 except for changing the composition of the hard coat layer-forming coating liquid to the following composition.

### (Composition of Hard Coat Layer-Forming Coating Liquid)

PE-3A (product of Kyoeisha Chemical Co., Ltd.): 80 parts by weight

BGV-12 (product of Soken Chemical and Engineering, Co., Ltd.): 20 parts by weight

Irgacure-184: 5 parts by weight

Methyl acetate: 80 parts by weight

Methylisobutylketone: 20 parts by weight

### Example 3

A hard coat film was prepared in the same manner as in Example 1 except for changing the composition of the hard coat layer-forming coating liquid to the following composition.

### (Composition of Hard Coat Layer-Forming Coating Liquid)

PE-3A (product of Kyoeisha Chemical Co., Ltd.): 80 parts by weight

BGV-12 (product of Soken Chemical and Engineering, Co., Ltd.): 20 parts by weight

Irgacure-184: 5 parts by weight

Methyl acetate: 20 parts by weight

Methylisobutylketone: 80 parts by weight

### Comparative Example 1

A hard coat film was prepared in the same manner as in Example 1 except for changing the composition of the hard coat layer-forming coating liquid to the following composition.

### (Composition of Hard Coat Layer-Forming Coating Liquid)

PE-3A (product of Kyoeisha Chemical Co., Ltd.): 100 parts by weight

Irgacure-184: 5 parts by weight

Methyl acetate: 50 parts by weight

Methylisobutylketone: 50 parts by weight

### Comparative Example 2

A hard coat film was prepared in the same manner as in Example 1 except for changing the composition of the hard coat layer-forming coating liquid to the following composition.

### (Composition of Hard Coat Layer-Forming Coating Liquid)

PE-3A (product of Kyoeisha Chemical Co., Ltd.): 50 parts by weight

BGV-12 (product of Soken Chemical and Engineering, Co., Ltd.): 50 parts by weight

Irgacure-184: 5 parts by weight

Methyl acetate: 50 parts by weight

Methylisobutylketone: 50 parts by weight

### Comparative Example 3

A hard coat film was prepared in the same manner as in Example 1 except for changing the composition of the hard coat layer-forming coating liquid to the following composition.

### (Composition of Hard Coat Layer-Forming Coating Liquid)

PE-3A (product of Kyoeisha Chemical Co., Ltd.): 80 parts by weight

BGV-12 (product of Soken Chemical and Engineering, Co., Ltd.): 20 parts by weight

Irgacure-184: 5 parts by weight

Methylisobutylketone: 50 parts by weight

Toluene: 50 parts by weight

The hard coat films of Examples and Comparative Examples were evaluated in accordance with the following method.

### (a) Haze (Transparency)

Transparency of each of the hard coat films of Examples and Comparative Examples was measured by using an image clarity measurement device (NDH-2000: product of Nippon Denshoku).

### (b) Adhesion

Evaluation of adhesion between the hard coat layer and the triacetylcellulose film of each of the hard coat films of Examples and Comparative Examples was performed by employing a grid taping method in accordance with JIS K5400. Each of the hard coat films was fixed on a steel plate, and a surface of the hard coat layer was cut by using a cutter to form a grid on the surface, thereby obtaining a grid of 100 squares (10 squares×10 squares). The size of each of the squares was 1 mm×1 mm. Across peel test was performed on the 100 squares (10 squares×10 squares). In the cross peel test, a cellophane adhesive tape was adhered to the cuts of the grid and then peeled off, and a state of adhesion between the hard coat layer and the triacetylcellulose film was confirmed by using a microscope. Evaluation results are represented by x/100 (x is the number of squares that were not peeled).

### (c) Surface Hardness

On the hard coat films of Examples and Comparative Examples, a scratch test was performed based on JIS K5400 by using a coating film pencil scratch tester (Tester Sangyo Co., Ltd.) and applying a load of 500 g on a 4H pencil. The test was performed for 5 times, and the number of tests in which no scratches were confirmed on the hard coat layer by visual observation was counted. Evaluation results are represented by x/5 (x is the number of tests in which no scratches were confirmed on the hard coat layer surface).

### (d) Curling

Each of the hard coat films of the Examples and Comparative Examples was cut into the size of 50 mm×2 mm, and a curvature radius R of the longitudinal side (50 mm) of each of the hard coat films cut into the size of 50 mm×2 mm was detected.

Evaluation results of the hard coat films of the Examples and Comparative Examples are shown in Table 1.

TABLE 1

| | Hard Coat | | Adhesion | | Curling |
|---|---|---|---|---|---|
| | Layer | | (remaining | Pencil Hardness | Curvature |
| | Thickness | Haze | squares/ | (no scratches/ | Radius R |
| | (μm) | (%) | 100 squares) | 5 tests) | (mm) |
| Ex. 1 | 12 | 0.2 | 100/100 | 4/5 | 80 |
| Ex. 2 | 12 | 0.2 | 100/100 | 3/5 | 80 |
| Ex. 3 | 12 | 0.2 | 100/100 | 4/5 | 80 |
| Comp. | 12 | 0.2 | 100/100 | 4/5 | 40 |
| Ex. 1 | | | | | |
| Comp. | 12 | 0.2 | 100/100 | 1/5 | >100 |
| Ex. 2 | | | | | |
| Comp. | 12 | 0.2 | 0/100 | 4/5 | 80 |
| Ex. 3 | | | | | |

What is claimed is:

1. A hard coat film comprising a triacetylcellulose film and a hard coat layer formed on the triacetylcellulose film, wherein:
the hard coat layer is formed by a coating step for forming a coating film on the triacetylcellulose film by directly applying a hard coat layer-forming coating liquid on the triacetylcellulose film, a drying step for drying the coating film, and a curing step for curing the coating film by irradiating the coating film with ionizing radiation;
the hard coat layer forming-coating liquid comprises a polyfunctional monomer (A) containing two or more (meth)acryloyl groups in one molecule and a crosslinking polymer (B) having a carbon-carbon unsaturated bonding; and
the crosslinking polymer (B) is contained in the hard coat layer-forming coating liquid at a ratio of from 10 parts by weight or more to 40 parts by weight or less with respect to 100 parts by weight of a total of the polyfunctional monomer (A) and the crosslinking polymer (B).

2. The hard coat film according to claim 1, wherein
the crosslinking polymer (B) having the carbon-carbon unsaturated bonding at a side chain in the hard coat layer-forming coating liquid has a weight average molecular weight (Mw) of from 2,000 or more to 50,000 or less.

3. The hard coat film according to claim 1, wherein
the hard coat layer does not contain particles.

4. The hard coat film according to claim 1, wherein
the hard coat layer has a thickness of from 3 μm or more to 20 μm or less.

5. The hard coat film according to claim 1, wherein
the hard coat layer is directly formed on the triacetylcellulose film, and
the hard coat layer-forming coating liquid further contains a solvent comprising a solvent (C) that dissolves triacetylcellulose and a solvent (D) that does not dissolve triacetylcellulose, the solvent (C) that dissolves triacetylcellulose being comprised at a ratio of from 30 parts by weight or more to 70 parts by weight or less with respect to 100 parts by weight of a total solvent amount.

6. A hard coat film comprising a triacetylcellulose film and a hard coat layer directly formed on the triacetylcellulose film, wherein
a curling curvature radius of a longitudinal side of a sheet of the hard coat film having a size of 50 mm×2 mm is 80 mm or more,
a result of experiment obtained by conducting a test of moving a pencil of 4H on a surface of the hard coat layer of the hard coat film with a load of 500 g being applied by using a coating film pencil scratch tester for 5 times is such that no scratches are observed on the hard coat layer surface in 3 or more tests out of the 5 tests,
a result of a cross cut peel test conducted by forming 100 squares each having a size of 1 mm×1 mm on the hard coat layer surface by cutting is such that a number of remaining squares of the hard coat layer is 100, and
a haze value of the hard coat film is 0.4% or less.

7. The hard coat film according to claim 1, wherein
the hard coat film comprises an anti-reflection layer formed on the hard coat layer.

8. A polarization plate comprising:
the hard coat film according to claim 1,
a polarization layer, and
another triacetylcellulose film, the polarizing layer and the another triacetylcellulose film being provided on a surface opposite to a surface of the triacetylcellulose film on which the hard coat layer is formed.

9. A hard coat film comprising a triacetylcellulose film and a hard coat layer formed on the triacetylcellulose film, wherein
the hard coat layer has a crosslink structure of a polyfunctional monomer (A) having two or more (meth) acryloyl groups in one molecule and a crosslinking polymer (B) having a carbon-carbon unsaturated bonding.

10. The hard coat film according to claim 9, wherein
the crosslinking polymer (B) is contained at a ratio of from 10 parts by weight or more to 40 parts by weight or less with respect to 100 parts by weight of a total of the polyfunctional monomer (A) and the crosslinking polymer (B).
